(19) United States
(12) Patent Application Publication
(10) Pub. No.: US 2008/0044576 A1
(43) Pub. Date: Feb. 21, 2008

(54) Method and Apparatus for Applying Thermal Interface Material

(76) Inventors: John L. Colbert, Byron, MN (US); Jason R. Eagle, Kasson, MN (US); Amanda E. Ennis Mikhail, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/464,913

(22) Filed: Aug. 16, 2006

(51) Int. Cl. B05C 11/11; B05D 5/00

(52) U.S. Cl. 427/272; 118/504; 118/213; 427/282

(57) ABSTRACT

An apparatus for applying thermal interface material (TIM) is disclosed. The apparatus has a substantially rigid frame with four corners. The frame includes a cross-shape opening having four tapered arms, and each of the four tapered arms is oriented towards one of the four corners of the frame.

### BACKGROUND OF THE INVENTION

1. Technical Field

The present invention relates to thermal interface material in general, and, in particular, to a method and apparatus for applying thermal interface material on chip package assemblies.

2. Description of Related Art

Thermal interface material (TIM) is traditionally applied to the bottom of a heatsink to allow for optimal heat transfer between an electronic component and the heatsink. Grease or gel-like materials that contain thermally conductive particles in suspension are commonly chosen as TIM.

In a typical TIM application, a designated volume of TIM is applied to a heatsink or chip surface, and the TIM is then compressed during the assembly of the heatsink and chip. However, it is often problematic when applying TIM to chips because the shapes of most chips are commonly square while the shapes of existing TIM stencils and their resulting impressions are generally round. The problem lies upon the difficultly in controlling the flow of TIM due to the viscous nature of grease or gel and the tendency of compressed fluids to form a circular shape due to typical flow vectors and material surface tension. As a result, either incomplete coverage of TIM will occur at the corners of a chip where optimal heat transfer via TIM is typically required or excess TIM will overflow into regions of critical components.

To make matters worse, TIM is often applied in a much larger quantity than what is needed (such as five times more than the required volume). When the heatsink is assembled with its mating chip, the excess TIM will be squeezed out from the interface between the heatsink and the chip. However, there is no control of the excess TIM that flows out due to the fact that any restrictive barriers can compromise contact between the heatsink surface and the chip. In addition, for most applications, TIM is not permitted to be squeezed out of the interface beyond the perimeter of the chip because adjacent electronic components can be potentially damaged by the overflowing excess TIM.

Consequently, it would be desirable to provide an improved method and apparatus for applying TIM.

### SUMMARY OF THE INVENTION

In accordance with a preferred embodiment of the present invention, a stencil for applying thermal interface material (TIM) has a substantially rigid frame with four corners. The frame includes a cross-shape opening having four tapered arms, and each of the four tapered arms is oriented towards one of the four corners of the frame.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of an apparatus for applying thermal interface material (TIM), in accordance with a preferred embodiment of the present invention;

FIG. 2 is a diagram of a cross-shape TIM impression on a heatsink, in accordance with a preferred embodiment of the present invention; and

FIGS. 3-4 are diagrams of the heatsink from FIG. 1 along with its component module, in accordance with a preferred embodiment of the present invention.

### DETAILED DESCRIPTION OF A PREFERRED EMBODIMENT

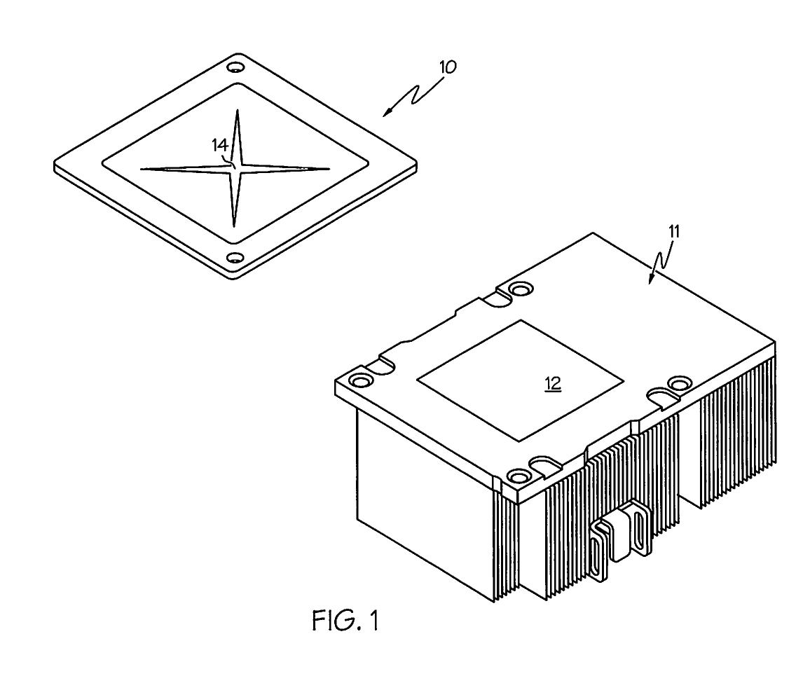

Referring now to the drawings and in particular to FIG. 1, there is depicted an apparatus for applying thermal interface material (TIM) in relation to a heatsink, in accordance with a preferred embodiment of the present invention. As shown, a TIM stencil 10 includes a cross-shape (x-shape) opening 14. Cross-shape opening 14 has four tapered arms, each oriented towards one of the four corner regions of TIM stencil 10. TIM stencil 10 is preferably made of metal.

TIM stencil 10 can be set upon a heatsink 11 by aligning the four corners of TIM stencil 10 with the four corners of a smooth surface 12 on heatsink 11. TIM, such as grease or gel, is subsequently applied to TIM stencil 10. Since the arms of cross-shape opening 14 are tapered, relatively less amount of TIM will be deposited at the corner regions of TIM stencil 10. In fact, only a small amount of TIM will be deposited at the corner of TIM stencil 10.

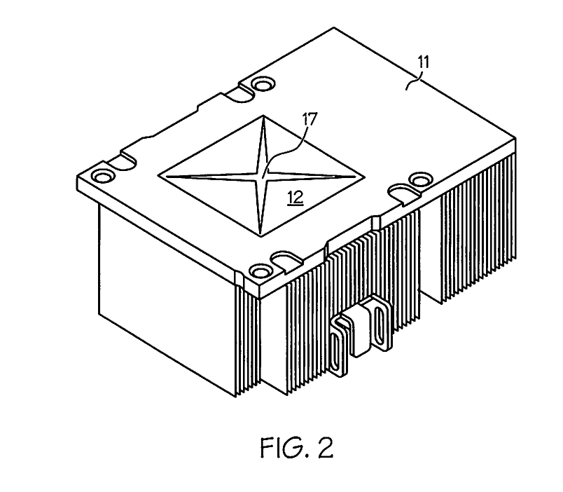

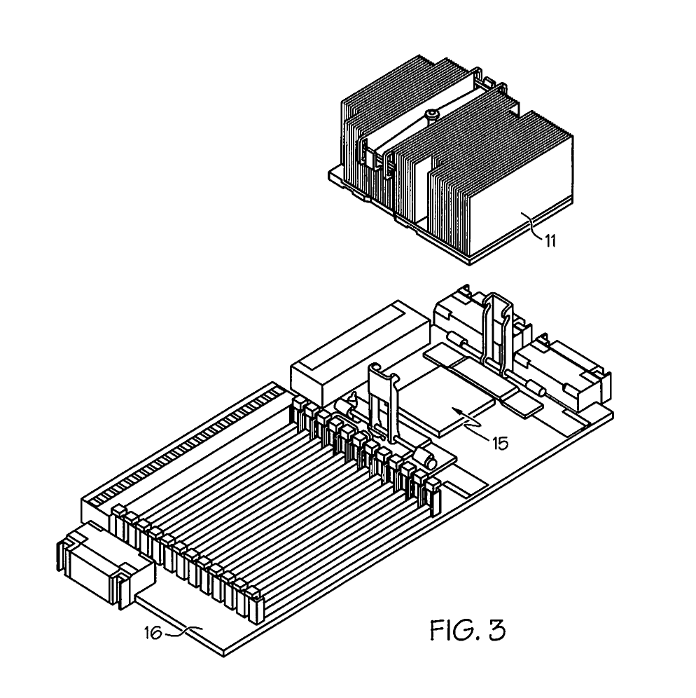

In order to achieve a final TIM thickness (after compression) of approximately 1.5 mils (0.0381 mm) on surface 12 of heatsink 11, the volume of TIM to be applied is approximately 85 mm³. TIM is stenciled onto surface 12 of heatsink 11 in a cross-shape as outlined by the opening of TIM stencil 10, at a thickness of 12 mils (0.305 mm) thick. The excess amount of TIM is preferably wiped away from TIM stencil 10 in order to form a precise impression of TIM 17 on surface 12 of heatsink 11, as depicted in FIG. 2.

As shown in FIG. 2, the cross-shape opening of TIM stencil 10 allows TIM impression 17 to be applied on surface 12 in a cross-shape with each arm tapers to a point in each of the four corners of surface 12. The decrease of the aspect ratio of the width of the arms of the cross-shape TIM impression 17 as well as the lengthening of the tapering region are instrumental to obtaining the final (compressed) square TIM impression. The “points” define the corners of the final impression, and the TIM from the thicker portion of the cross-shape TIM impression 17 flows outward to define a square.

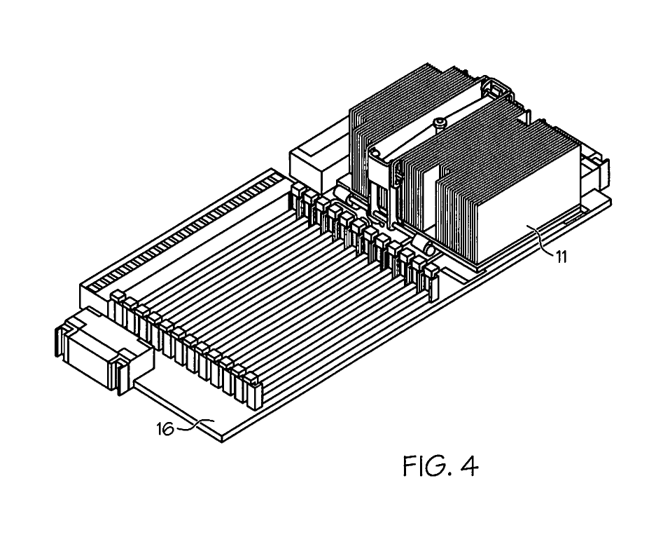

Heatsink 11 can then be assembled with a chip assembly 15 located on a component module 16. After the loading feature (not shown) is engaged, the loading feature forces TIM on heatsink 11 to flow from the initial cross-shape impression to cover the substantially square-shape chip assembly 15 precisely. The final assembly is shown in FIG. 4.

As has been described, the present invention provides an improved method and apparatus for applying TIM. A TIM stencil that optimizes the shape and volume of TIM is applied to the bottom of a heatsink by optimizing the flow of excess TIM to the corners of the application region. With the present invention, the goal of complete coverage of the square chip/heatsink interface can be achieved without any excess TIM being squeezed out of the interface.

While the invention has been particularly shown and described with reference to a preferred embodiment, it will be understood by those skilled in the art that various changes in form and detail may be made therein without departing from the spirit and scope of the invention.

What is claimed is:

1. A stencil for applying thermal interface material (TIM), said stencil comprising:
a substantially rigid frame having four corners; and
a cross-shape opening having four tapered arms, each oriented towards one of said four corners of said frame.

2. The stencil of claim 1, wherein said stencil is made of metal.

4. The stencil of claim 1, wherein said TIM is made of grease or gel-like materials.

5. An apparatus for applying thermal interface material (TIM), said apparatus comprising:
a substantially rigid frame having four corners; and
a x-shape opening having four tapered arms, each oriented towards one of said four corners of said frame.

6. The apparatus of claim 5 wherein said apparatus is made of metal.

6. The apparatus of claim 5, wherein said TIM is made of grease or gel-like materials.

7. A method for applying thermal interface material (TIM), said method comprising:
placing a TIM stencil on top of a smooth surface of a heatsink, wherein said TIM stencil includes
a substantially rigid frame having four corners; and
a x-shape opening having four tapered arms, each oriented towards one of said four corners of said frame;
applying TIM to said TIM stencil to yield a TIM impression on said smooth surface of said heatsink.

8. The method of claim 3, wherein said apparatus is made of metal.

9. The method of claim 3, wherein said TIM is made of grease or gel-like materials.
